(19) United States
(12) Patent Application Publication
(10) Pub. No.: US 2019/0311315 A1
(43) Pub. Date: Oct. 10, 2019

(54) SYSTEM FOR AFFILIATING PARCEL SERVICE TARGETING AT UNSPECIFIED INDIVIDUALS AND METHOD FOR DELIVERING ARTICLE BY USING THE SAME

(71) Applicant: Na Yun KIM, Yongin-si (KR)

(72) Inventor: Na Yun KIM, Yongin-si (KR)

(21) Appl. No.: 15/996,599

(22) Filed: Jun. 4, 2018

(30) Foreign Application Priority Data
Apr. 9, 2018 (KR) 10-2018-0040924

(51) Int. Cl. G06Q 10/08; G06Q 20/28

(52) U.S. Cl. CPC G06Q 10/083; G06Q 20/28

(57) ABSTRACT

Provided is a system for affiliating a parcel service targeting at unspecified individuals, wherein since unspecified individuals can participate as a courier and a carrier, a delivery requester is not interrupted by time and needs not pack an article, thereby achieving convenient delivery, a carrier can make money during leisure time or daily life, and a recipient can receive an article within a short time. The system includes: an administrator server; a delivery requester terminal configured to register an article delivery request of an unspecified person to the administrator server; and a carrier terminal configured to receive the delivery request registered in the administrator server and support pickup and transportation of the article by the unspecified person.

### RELATED APPLICATION

This application claims the benefit of Korean Patent Application No. 10-2018-0040924, filed on Apr. 9, 2018, in the Korean Intellectual Property Office, the disclosure of which is incorporated herein in its entirety by reference.

### BACKGROUND OF THE INVENTION

### 1. Field of the Invention

The present invention relates to a system for affiliating a parcel service, and more particularly, to a system for affiliating a parcel service targeting at unspecified individuals, wherein since unspecified individuals can participate as a courier and a carrier, a delivery requester is not interrupted by time and needs not pack an article, thereby achieving convenient delivery, a carrier can make money during leisure time or daily life, and a recipient can receive an article within a short time.

### 2. Description of the Related Art

Recently, due to the busy daily life of the modern people and the development of the Internet, a method of delivering an article through a parcel service when the article is ordered by phone or online is generally used. A quick service is used when an article has to be delivered more quickly than a parcel service.

As for a general parcel service, a charge for a parcel service is prepaid when an article is ordered or paid on delivery. A deliverer who delivers articles classified by the destination of the same area while unloading articles, collected in a warehouse of a freight forwarding company, from a vehicle scans a tag such as a barcode attached to an article so as to deliver the article to the corresponding area, and the article is delivered to a recipient's address of an invoice.

Meanwhile, the quick service is a logistics service that directly receives an article to be delivered at a departure point designated by a customer and delivers the article to a destination fast and safely. A vehicle used for delivery is mainly a motorcycle in a downtown area. For long-distance delivery, transportation means including a truck, an express bus, or the like is used.

In such a quick service distribution system, when a customer requests delivery to a logistics center, the logistics center that receives the delivery request assigns a rider who is a member, the rider takes an article at a departure point and completes the delivery to a destination, and the logistics center pays the rider the amount of the carrying charge deposited by the customer, excluding the commission.

However, the conventional parcel service or quick service delivery method as described above have the following problems.

1) In the case of the parcel service, it takes a certain period of time to deliver an article as the delivery is done by entrusting to a specialized company such as a freight forwarding company.

2) It is necessary to attach an invoice to an article to be delivered and to pack the article into a box.

3) In case of the quick service, similarly to the parcel service, fast delivery is possible by entrusting to a specialized company, but the cost for the delivery is high.

4) Service time is limited for both the parcel service and the quick service (unavailable for 24 hours).

Therefore, in order to overcome the above problems, more efficient parcel delivery methods are required.

### PRIOR ART DOCUMENT

### Patent Document

### (Patent Literature 001) Korean Patent Registration No. 10-0546795

### (Patent Literature 002) Korean Patent Application Publication No. 10-2007-0098141

### SUMMARY OF THE INVENTION

The present invention has been made in an effort to solve the above-described problems of the related art, and provides a system for affiliating a parcel service targeting at unspecified individuals, capable of making convenient delivery request, profit by transportation, and quick receipt of an article with respect to everyone who wants to participate as an article delivery requester and a carrier.

According to one or more embodiments, there is provided a system for affiliating a parcel service targeting at unspecified individuals, including: an administrator server; a delivery requester terminal configured to register an article delivery request of an unspecified person to the administrator server; and a carrier terminal configured to receive the delivery request registered in the administrator server and support pickup and transportation of the article by the unspecified person.

The system may further include a recipient terminal configured to receive an article transportation situation through the administrator server.

The administrator server may include a delivery charge payment module configured to enable a prepayment of the delivery charge through the delivery requester terminal, and the delivery charge payment module may send a payment guidance message to the recipient terminal in case of payment on delivery. The delivery charge may be different according to at least one selected from a distance from a pickup location to a destination, a quantity, a weight, and a size of the article, and is divided into a carrier charge and an administrator server operation charge.

The administrator server may include a membership module configured to join at least one of the delivery requester, the carrier, and the recipient as a member, and the recipient terminal may be allowed to receive an article transportation situation with respect to non-members among recipients. The administrator server may include a carrier evaluation module configured to allow the delivery requester terminal to confirm the evaluation on the carrier.

The administrator server may include a delivery request notification module configured to notify a delivery request registration situation to a carrier terminal within a certain distance based on an article pickup location. The administrator server may include a local delivery alarm module configured to transmit an alarm message to a carrier terminal designating a corresponding area as a transportation activity area when a delivery request in a specific area is registered. The administrator server may include an insurance subscription module configured to support compensation for loss or damage of the article requested by the delivery requester terminal. The administrator server may include a delivery requester evaluation module configured to allow the carrier terminal to confirm the evaluation on the delivery requester.

When two or more unspecified persons accept the delivery request registered in the administrator server, the delivery requester terminal may be allowed to select a specific person as the carrier based on the evaluation on the carrier.

The delivery requester terminal may be allowed to register at least one of an image, a size, a weight, contents, a recipient contact, a pickup location, a destination, and a delivery charge from the pickup location to the destination of an article to the administrator server so as to be confirmed by the carrier terminal. The delivery requester terminal may be allowed to transmit at least one of an image, a sound source, a voice, a photograph, and a message to the recipient terminal.

The carrier terminal may receive a guidance of at least one of an article pickup location and a destination route through the administrator server or an existing navigation system. The carrier terminal may register account information for cost settlement to the administrator server after completion of the article transportation, and the administrator server may include a cost settlement module configured to confirm the completion of the article transportation through at least one of the delivery requester terminal, the carrier terminal, and the recipient terminal and settle the cost.

The carrier terminal may be allowed to register at least one of a resident registration number, a photograph, a name, a contact, a vehicle number, a transportation means, a real-time location, and an estimated destination arrival time to the administrator server so as to be confirmed by at least one of the delivery requester terminal and the recipient terminal.

According to one or more embodiments, there is provided an article delivery method including: a delivery request registering step of registering, by the delivery requester terminal, an article delivery request of an unspecified person to the administrator server; a delivery supporting step of receiving, by the carrier terminal, a registered delivery request and supporting an article pickup and transportation of the unspecified person; and a transportation situation confirming step of receiving, by the recipient terminal, an article transportation situation so as to allow receipt of an article being delivered.

The article delivery method may further include: a delivery request notifying step of notifying, by the administrator terminal, a delivery request registration situation to the carrier terminal within a certain distance based on an article pickup location; and a local delivery alarming step of transmitting, by the administrator server, an alarm message to a carrier terminal designating a corresponding area as a transportation activity area when a delivery request in a specific area is registered.

The article delivery method may further include: a carrier evaluating step of registering, by at least one of the delivery requester terminal and the recipient terminal, the evaluation on the carrier to the administrator server; and a delivery requester evaluating step of registering, by the carrier terminal, the evaluation on the delivery requester to the administrator server.

The article delivery method may further include a cost settling step of confirming, by the administrator server, the completion of the article transportation through at least one of the delivery requester terminal, the carrier terminal, and the recipient terminal and settling a delivery charge to an account registered through the carrier terminal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram of a system for affiliating a parcel service targeting at unspecified individuals according to the present invention;

FIG. 2 is a block diagram illustrating elements of an administrator server in the system for affiliating the parcel service targeting at unspecified individuals according to the present invention;

FIG. 3 is a flowchart of a delivery process using the system for affiliating the parcel service targeting at unspecified individuals according to the present invention; and

FIG. 4 is a flowchart of an article delivery process using the system for affiliating the parcel service targeting at unspecified individuals according to the present invention.

### DESCRIPTION OF THE PREFERRED EMBODIMENTS

In the following detailed description of the present invention, references are made to the accompanying drawings that show, by way of illustration, specific embodiments in which the present invention may be implemented. These embodiments are described in sufficient detail to enable those skilled in the art to implement the present invention. It should be understood that various embodiments of the present invention, although different, are not necessarily mutually exclusive. For example, specific features, structures, and characteristics described herein, in connection with one embodiment, may be implemented within other embodiments without departing from the spirit and scope of the present invention. In addition, it should be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range equivalent to what the claims claim. In the drawings, like reference numbers refer to the same or similar function through many ways.

Hereinafter, a system for affiliating a parcel service targeting at unspecified individuals according to the present invention will be described with reference to the accompanying drawing.

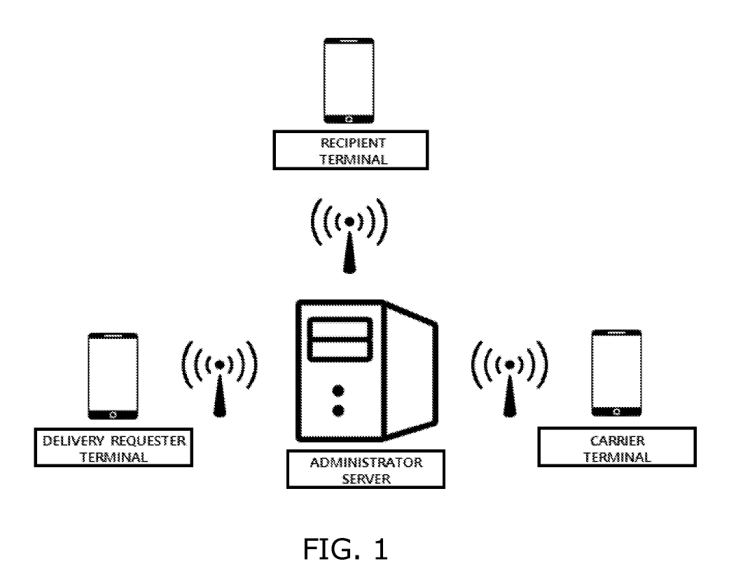

FIG. 1 is a schematic diagram of a system for affiliating a parcel service targeting at unspecified individuals according to the present invention.

The present invention basically includes an administrator server, a delivery requester terminal, and a carrier terminal.

More specifically, the present invention may include an administrator server, a delivery requester terminal for registering an article delivery request of an unspecified individual to the administrator server, a carrier terminal for receiving the delivery request registered in the administrator server and supporting pickup and transportation of the article by unspecified individual and and may further include a recipient terminal for receiving an article transportation situation through the administrator server.

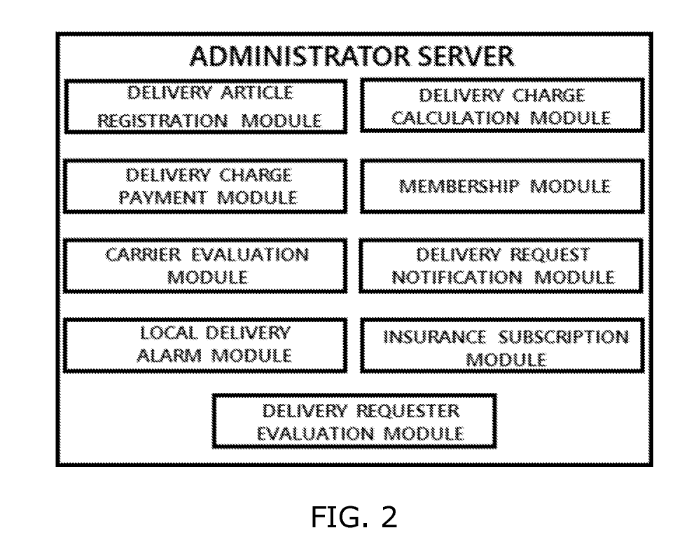

FIG. 2 is a block diagram illustrating elements of the administrator server in the system for affiliating the parcel service targeting at unspecified individuals according to the present invention.

The administrator server may communicate with the delivery requester terminal, the carrier terminal, and the recipient terminal on an online network in real time, and perform the entire processes related to delivery request receipt/registration, delivery charge pricing/payment, membership, evaluation on carrier/delivery requester, article pickup location/destination guide, delivery requester/carrier information registration, and the like. Details thereof will be described below.

<Main Elements, Functions, and Effects of Administrator Server>

Delivery Article Registration Module
The image, size, weight, quantity, contents, recipient contact, pickup location, and destination, delivery charge from a pickup location to a destination of an article to be delivered, and the like can be registered through the delivery requester terminal so that it can be confirmed by the carrier terminal.
The delivery charge pricing can be different according to a size, a weight, a quantity, a distance from the pickup location to the destination of the article, or the like.

Delivery Charge Calculation Module
The delivery charge is calculated based on a size, a weight, a quantity, a distance from the pickup location to the destination of the article, and the like, and the delivery charge can be confirmed by the delivery requester terminal, the carrier terminal, and the recipient terminal.

Delivery Charge Payment Module
The delivery charge prepayment process can be performed through the delivery requester terminal. When paid on delivery, the payment guidance message can be transmitted to the recipient terminal. The payment on delivery can be performed by the recipient terminal.
The delivery charge is different according to a distance from a pickup location to a destination, a quantity, a weight, a size of the article, and the like and is divided into a carrier charge and an administrator server operation charge.
The payment details based on a distance, a quantity, a weight, a size, and the like are notified.

Membership Module
The process of joining the delivery requester, the carrier, and the recipient as members is performed.
In order to register as the carrier, the identity must be objectively authenticated through membership registration.
The recipient terminal can receive the article delivery situation even with respect to the non-members among the recipients (for example, a text such as the carrier departure, the carrier location, or the carrier arrival is sent through the contact, SNS of the non-member, or the like)
Connection link such as software or application for inducing member registration is simultaneously transmitted to the administrator server when sending a text to the non-members among the recipients.

Carrier Evaluation Module
The evaluation on the carrier can be checked on the delivery requester terminal to thereby ensure the reliability of the carrier and pay attention to the transportation of the article (for example, the carrier is evaluated through comments on the past delivery completion of the carrier, evaluation points, or the like)
New carrier is separately marked.
If two or more unspecified persons accept the delivery request registered in the administrator server, the delivery requester terminal can select a specific person as the carrier based on the evaluation on the carrier.

Delivery Request Notification Module
The delivery request registration situation is notified to the carrier terminal within a certain distance based on the article pickup location.
To avoid unnecessary delivery request information to the carrier.

Local Delivery Alarm Module
When a delivery request in a specific area is registered, an alarm message is sent to the carrier terminal that has designated the area as a transportation activity area.
It is possible to exclude unnecessary delivery request information to the carrier.
It is possible to set the pickup area and the delivery destination area so that the delivery request can be confirmed on the daily moving route

Insurance Subscription Module
Compensation for loss or damage of the article requested by the delivery requester terminal is supported.
It is possible to prepare for accidents by insurance when requesting the delivery of important articles.
The insurance subscription module can interwork with the insurance company server.

Delivery Requester Evaluation Module
The evaluation on the delivery requester can be checked on the carrier terminal to thereby ensure the reliability of the delivery requester and preventing the non-payment of the delivery charge after the delivery (for example, the delivery requester is evaluated through comments or evaluation points with respect to the past delivery request history of the delivery requester)
New delivery requester is separately marked.
If two or more delivery requests that can be performed by the carrier are registered in the administrator server, the carrier terminal can select a specific delivery requester based on the evaluation on the delivery requester.

Meanwhile, the delivery requester terminal registers an image, a size, a quantity, a weight, contents, a recipient contact, a pickup location, a destination, a delivery charge from the pickup location to the destination of the article, and the like to the administrator server through the delivery article registration module, so that the delivery requester terminal, the carrier terminal, and the recipient terminal can share all or part of the information with one another.

The delivery charge is automatically priced differently according to the size, quantity, weight, distance from the pickup location to the destination of the article, and the like while interworking with the delivery charge calculation module of the administrator server.

In addition, the delivery requester terminal can transmit images, sound sources, voices, pictures, messages, and the like to the recipient terminal. In addition to the simple delivery of the article to the recipient, the emotion of the sender can be transferred together with the article. Therefore, the emotion of the sender can be expressed by the images, sound sources, voices, pictures, messages, and the like in a situation in which the emotional expression of the sender is required, for example, anniversary celebration, proposal, or the like, thereby doubling the impressions received by the recipient.

The carrier terminal receives the route guidance of the pickup location route and the destination route of the article by interworking with the administrator server or the existing navigation system. For example, when transportation means such as public transportation, walking, or car is designated, the user can receive the route guidance for the transportation means and conveniently move to the pickup location or destination.

In addition, when the carrier terminal registers account information for cost settlement in the administrator server after completion of the transportation of the article, the administrator server may include a cost settlement module for confirming the completion of the article transportation through the delivery requester terminal, the carrier terminal, and the recipient terminal and then settle the cost.

For example, when an article, of which the delivery charge is 10,000 won, is transferred to the recipient and then the carrier and the recipient (partial or entire combination of other third parties are possible) transmit a transportation completion signal to the administrator server, the cost settlement module may function to remit the remaining amount excluding the commission to the account registered through the carrier terminal within a predetermined period.

In addition, the carrier terminal may register a resident registration number, a photograph, a name, a contact, a vehicle number, a transportation means (public transportation, private use, walking, or the like), a real-time location, an estimated destination arrival time, and the like in the administrator server, and thus it is possible to confirm information about the carrier in the delivery requester terminal and the recipient terminal registered in the administrator server as a member.

The carrier information is used by the administrator server to verify the identity of the carrier and assign responsibility to the carrier for loss or damage of the article, may be used to make it easier for the delivery requester or the recipient to identify the carrier, and may be used to confirm the transportation means of the carrier and confirm the estimated arrival time to the destination.

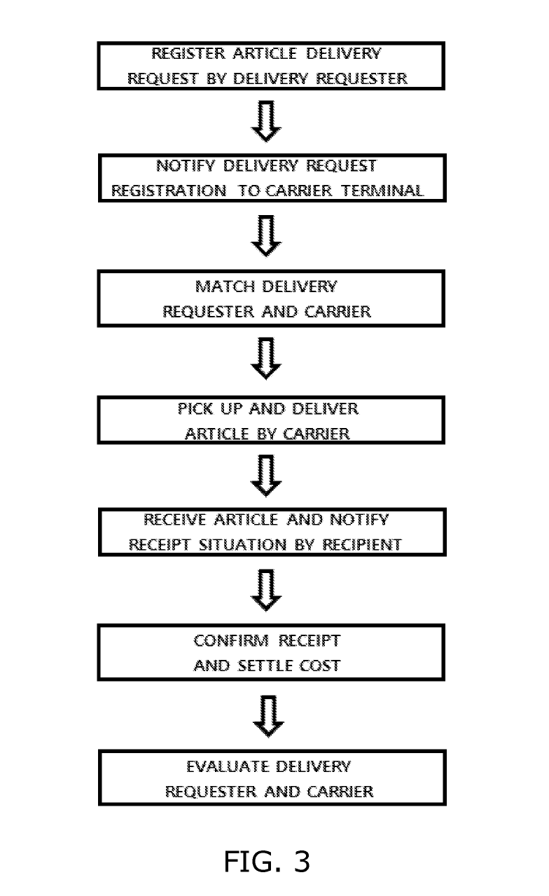

FIG. 3 is a flowchart of a delivery process using the system for affiliating the parcel service targeting at unspecified individuals according to the present invention.

An embodiment of the delivery process according to the present invention is as follows.

1) Delivery requester: To register the article delivery request through the delivery requester terminal (delivery charge prepayment is possible).

2) Administrator server: To notify the article delivery requests to the carrier terminal.

3) Carrier: To transfer the article delivery request acceptance after confirming whether the delivery condition desired by the user is matched through the carrier terminal.

4) Administrator server: To match the delivery requester and the carrier.

5) Carrier: To move to the article pickup location, pick up the article, move to the destination, and deliver the article to the recipient (the carrier terminal guides the pickup location and the destination route according to the transportation means such as public transportation, walking, or car).

6) Recipient: To receive the article (delivery charge prepayment is possible) and transmit the receipt completion situation to the administrator server.

7) Administrator server: After checking the article receipt completion situation, to remit the amount excluding the commission in the delivery charge to the carrier account.

8) Delivery requester or carrier: To transmit the evaluation on the carrier or the delivery requester to the administrator server.

9) Administrator server: To store the evaluation information on the delivery requester or the carrier.

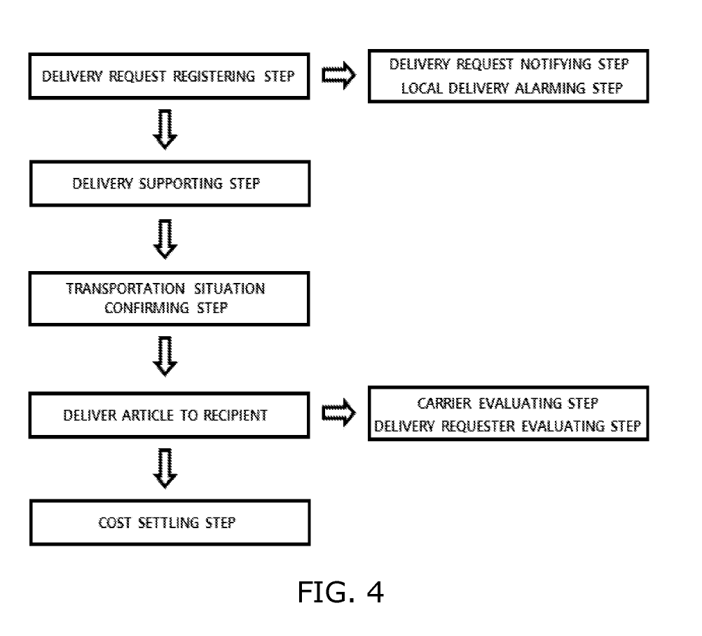

FIG. 4 is a flowchart of an article delivery method using the system for affiliating the parcel service targeting at unspecified individuals according to the present invention.

The article delivery method according to the present invention includes a delivery request registering step of registering, by the delivery requester terminal, an article delivery request of an unspecified person to the administrator server; a delivery supporting step of supporting article pickup and transportation of the unspecified person after the carrier terminal receives the registered delivery request, and a transportation situation confirming step of receiving the article transportation situation so that the recipient terminal can receive the article being delivered.

If the delivery request of the unspecified delivery requestor is registered in the administrator server through the above-described process, the unspecified carrier confirms the transportation conditions such as the size, weight, quantity, distance from the pickup location to the destination of the article, and the like, through the carrier terminal, and when the transportation is possible, matching between the delivery requester and the carrier is performed if the delivery request is accepted.

After that, the carrier receives the route guidance for the pickup location and the destination through the carrier terminal and delivers the article to the recipient. In the case of the recipient who does not join in the administrator server member, the recipient receives the location of the carrier through text, SNS, or the like. In the case of the recipient who has joined in the membership, the recipient receives the location of the carrier terminal in real time through a dedicated application installed on the recipient terminal (for example, the location of the carrier terminal can be confirmed on the online map in real time). Thus, when the carrier arrives at the destination, the recipient can conveniently receive the article.

The article delivery method may further include a delivery request notifying step of notifying the delivery request registration situation to the carrier server within a certain distance based on the article pickup location, and a local delivery alarming step of, when the delivery request in a specific area is registered, transmitting, by the administrator server, an alarm message to the carrier terminal that has designated the corresponding area as a transportation activity area. Therefore, it is possible to prevent the undesired delivery request registration situation from being transmitted to an undesired person who desires to transport or to check only the delivery receipt situation requested on the daily moving route.

Furthermore, a carrier evaluating step of registering, by at least one of the delivery requester terminal and the recipient terminal, the evaluation on the carrier to the administrator server and a delivery requester evaluating step of registering, by the carrier terminal, the evaluation on the delivery requester to the administrator server can make it possible to help to ensure the reliability of the carrier and to be careful when transporting the article. When two or more unspecified persons accept a delivery request registered in the administrator server, it is possible to select a specific person who is excellent in evaluation among the unspecified persons as the carrier based on the evaluation on the carrier.

Then, the administrator server confirms the completion of the article transportation through at least one of the delivery requester terminal, the carrier terminal, and the recipient terminal, and then, a cost settling step is performed to remit the amount excluding the administrator server operation charge from the delivery charge to the account registered in the administrator server through the carrier terminal.

For reference, the administrator server may also be configured to act as a web server or a web service server. For example, the processed result may be displayed on a web page, or necessary input data may be transmitted through a web page. Here, the web page should be construed as including software for performing specific tasks such as web applications, in addition to simple text, image, sound, and video. In addition, it may be desirable to provide an interface with an application used in the delivery requester terminal, the carrier terminal, and the recipient terminal.

The delivery requester terminal, the carrier terminal, and the recipient terminal should be construed as including various communication means such as a tablet, a netbook, a personal digital assistant (PDA), a portable multimedia player (PMP), a smart phone, a wearable smart device, and the like. The delivery requester terminal, the carrier terminal, and the recipient terminal may implement various functions provided by the administrator server or provide software and applications for interworking with the administrator server. Such software and applications may be separately divided to individually support the delivery requester, the carrier, and the recipient, or may be implemented in one so that three parities can use them at the same time.

The online network described in the present invention may be a core network integrated with a wired public network, a wireless mobile communication network, or a portable Internet, or may be a worldwide open computer network structure for providing TCP/IP protocol and several services existing in the upper layer, that is, hyper text transfer protocol (HTTP), Telnet, file transfer protocol (FTP), domain name system (DNS), simple mail transfer protocol (SMTP), or the like. The present invention is not limited to such examples, but encompasses a data communication network capable of exchanging data in various forms.

The system for affiliating the parcel service targeting at unspecified individuals according to the present invention can allow unspecified individuals to participate without limiting the role of the article carrier to the existing specialized companies, and can simply perform the entire processes of requesting, delivering, and receiving the article through a terminal such as a smartphone.

In addition, the delivery requester is not interrupted by time, can request the delivery service anytime, and needs not pack an article or prepare for an invoice, thereby achieving convenient delivery.

The carrier can make money through the delivery activity on the moving route during leisure time or daily life, thereby contributing to active participation of individuals.

In addition, the recipient can receive an article as fast as the quick service.

Furthermore, the delivery requester or the recipient can pay a lower cost than the quick service and receive a fast delivery service.

In the foregoing descriptions, although the present invention has been described in connection with the specific matters, such as the specific components, the specific embodiments, and the drawings, they are provided only for assisting in the understanding of the present invention, and the present invention is not limited to the embodiments. It will be apparent that those skilled in the art can make various modifications and changes thereto from these descriptions.

Therefore, the spirit of the present invention should not be limited to the aforementioned embodiments, and the appended claims and what are modified equally or equivalently thereto will be considered to fall within the scopes of the present invention.

What is claimed is:

1. A system for affiliating a parcel service targeting at unspecified individuals, comprising:
an administrator server;
a delivery requester terminal configured to register an article delivery request of an unspecified person to the administrator server; and
a carrier terminal configured to receive the delivery request registered in the administrator server and support pickup and transportation of an article by the unspecified person.

2. The system of claim 1, further comprising a recipient terminal configured to receive an article transportation situation through the administrator server.

3. The system of claim 2, wherein
the administrator server comprises a delivery charge payment module configured to enable a prepayment of a delivery charge through the delivery requester terminal, and
the delivery charge payment module sends a payment guidance message to the recipient terminal in case of payment on delivery.

4. The system of claim 3, wherein
the delivery charge is different according to at least one selected from a distance from a pickup location to a destination, a quantity, a weight, and a size of the article, and is divided into a carrier charge and an administrator server operation charge.

5. The system of claim 2, wherein
the administrator server comprises a membership module configured to join at least one of the delivery requester, the carrier, and the recipient as a member, and
the recipient terminal is allowed to receive the article transportation situation with respect to non-members among recipients.

6. The system of claim 1, wherein
the administrator server comprises a carrier evaluation module configured to allow the delivery requester terminal to confirm an evaluation on the carrier.

7. The system of claim 6, wherein
when two or more unspecified persons accept the delivery request registered in the administrator server, the delivery requester terminal is allowed to select a specific person as the carrier based on the evaluation on the carrier.

8. The system of claim 1, wherein
the administrator server comprises a delivery request notification module configured to notify a delivery request registration situation to the carrier terminal within a certain distance based on an article pickup location.

9. The system of claim 1, wherein
the administrator server comprises a local delivery alarm module configured to transmit an alarm message to the carrier terminal designating a corresponding area as a transportation activity area when the delivery request in a specific area is registered.

10. The system of claim 1, wherein
the administrator server comprises an insurance subscription module configured to support compensation for loss or damage of the article requested by the delivery requester terminal.

11. The system of claim 1, wherein
the administrator server comprises a delivery requester evaluation module configured to allow the carrier terminal to confirm an evaluation on the delivery requester.

12. The system of claim 1, wherein
the delivery requester terminal is allowed to register at least one of an image, a size, a weight, contents, a recipient contact, a pickup location, a destination, and a delivery charge from the pickup location to the destination of the article to the administrator server so as to be confirmed by the carrier terminal.

13. The system of claim 2, wherein
the delivery requester terminal is allowed to transmit at least one of an image, a sound source, a voice, a photograph, and a message to the recipient terminal.

14. The system of claim 1, wherein
the carrier terminal receives a guidance of at least one of an article pickup location and a destination route through the administrator server or an existing navigation system.

15. The system of claim 2, wherein
the carrier terminal registers account information for cost settlement to the administrator server after completion of the article transportation, and
the administrator server comprises a cost settlement module configured to confirm the completion of the article transportation through at least one of the delivery requester terminal, the carrier terminal, and the recipient terminal and settle the cost.

16. The system of claim 2, wherein
the carrier terminal is allowed to register at least one of a resident registration number, a photograph, a name, a contact, a vehicle number, a transportation means, a real-time location, and an estimated destination arrival time to the administrator server so as to be confirmed by at least one of the delivery requester terminal and the recipient terminal.

17. An article delivery method using the system for affiliating a parcel service targeting at unspecified individuals according to claim 1, comprising:
a delivery request registering step of registering, by the delivery requester terminal, the article delivery request of the unspecified person to the administrator server;
a delivery supporting step of receiving, by the carrier terminal, the registered delivery request and supporting the pickup and transportation of the article by the unspecified person; and
a transportation situation confirming step of receiving, by the recipient terminal, an article transportation situation so as to allow receipt of the article being delivered.

18. The article delivery method of claim 17, further comprising:
a delivery request notifying step of notifying, by the administrator terminal, a delivery request registration situation to the carrier terminal within a certain distance based on an article pickup location; and
a local delivery alarming step of transmitting, by the administrator server, an alarm message to the carrier terminal designating a corresponding area as a transportation activity area when the delivery request in a specific area is registered.

19. The article delivery method of claim 17, further comprising:
a carrier evaluating step of registering, by at least one of the delivery requester terminal and the recipient terminal, an evaluation on the carrier to the administrator server; and
a delivery requester evaluating step of registering, by the carrier terminal, an evaluation on the delivery requester to the administrator server.

20. The article delivery method of claim 17, further comprising a cost settling step of confirming, by the administrator server, the completion of the article transportation through at least one of the delivery requester terminal, the carrier terminal, and the recipient terminal and settling a delivery charge to an account registered through the carrier terminal.
